(19) United States
(12) Patent Application Publication
(10) Pub. No.: US 2009/0120534 A1
(43) Pub. Date: May 14, 2009

(54) Preflux Composition

(75) Inventor: Young-Sik Yoon, Seoul (KR)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Baik Yang Chemical Co. Ltd., Seoul (KR)

(21) Appl. No.: 11/994,525

(22) PCT Filed: Mar. 27, 2006
(86) PCT No.: PCT/KR2006/001116

§ 371 Date: Jun. 5, 2008

(30) Foreign Application Priority Data
Jul. 7, 2005 (KR) 10-2005-0061166

(51) Int. Cl. B23K 35/34

(52) U.S. Cl. 148/24

(57) ABSTRACT

The present invention relates to a preflux composition having excellent heat-resistance suited for the formation of a film on the surface of copper or copper alloy, and more precisely, a preflux composition having enhanced heat-resistance, compared with the conventional preflux composition, and capable of selectively coating a copper plating circuit. The preflux composition with high heat-resistance of the present invention is characteristically composed of 0.1-5 weight part of benzimidazole derivative, 0.5-20 weight part of organic acid or inorganic acid, 0.001-1 weight part of iron compound, 0.001-1.5 weight part of chelating agent, 0.0001-1 weight part of nickel compound and 0.01-1 weight part of iodine compound for 100 weight part of water.

### TECHNICAL FIELD

The present invention relates to a preflux composition having excellent heat-resistance suited for the formation of a film on the surface of copper or copper alloy, and more precisely, a preflux composition having enhanced heat-resistance, compared with the conventional preflux composition, and capable of selectively coating a copper plating circuit.

### BACKGROUND ART

Generally, a circuit has to be coated with either another metal such as lead, gold and palladium or organic coatings to maintain solderability and prevent rust on the surface of a copper or copper compound circuit of a printed circuit board.

Two major compositions of organic coatings are rosin preflux which coats the entire printed wiring board and an alkylimidazole preflux which coats a copper circuit part selectively by a chemical reaction.

To use rosin preflux, natural rosin, rosin ester, or rosin-modified maleate resin is dissolved in an organic solvent, and then the solution is spread, sprayed or precipitated on the entire printed circuit board, followed by drying to form a film. However, this method has problems in the working environment and safety since the organic solvent volatilizes.

The alkylimidazole preflux is water-soluble, excellent in the aspects of working environment and safety, and stable at around room temperature, but is quickly de-pigmented at high temperature, causing problems in soldering on the surface of the formed film.

Since the export of lead-containing products to Europe has been prohibited since 2006, silver, tin and zinc alloys have taken the place of lead. But, the melting points of these alloys are at least 20° C. higher than that of lead so the problem with the conventional preflux composition is that a color change occurs on the surface of the copper or copper alloy resulting from its poor heat-resistance.

### DISCLOSURE OF INVENTION

### Technical Solution

A preflux film with excellent heat-resistance must be formed on the surface of copper.

Therefore, an object of the present invention is to provide a preflux composition having higher heat-resistance than that of the conventional preflux composition to overcome the above problems.

It is another object of the present invention to provide a preflux composition selectively coating a copper plating circuit when a copper plating circuit and a gold plating circuit coexist.

### BEST MODE FOR CARRYING OUT THE INVENTION

The preflux composition of the present invention has excellent heat-resistance, compared with the conventional preflux composition, and is able to coat a copper plating circuit selectively. The present inventors have developed a preflux composition that has higher heat-resistance than that of the conventional preflux composition by using benzimidazole derivatives of the below formula 1 and other metal compounds, and they have completed this invention by confirming that the composition of the p resent invention has excellent heat-resistance even at a high temperature of 280° C.

Hereinafter, the preflux composition of the present invention is described in detail.

The preflux composition of the present invention contains 0.1-5 weight part of benzimidazole derivative of the below formula 1, 0.5-20 weight part of organic acid or inorganic acid, 0.001-1 weight part of iron compound, 0.001-1.5 weight part of chelating agent, 0.0001-1 weight part of nickel compound and 0.01-1 weight part of iodine compound for 100 weight part of water.

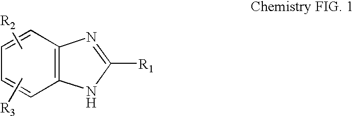

(Wherein, R₁ is an alkyl, halogen, aralkyl or allyl with one or more carbons, and R₂ and R₃ are independently H, C₁˜C₅ alkyl or a halogen.)

In another aspect of the present invention, the composition of the invention can additionally include one or more compounds selected from a group consisting of 0.001-1 weight part of copper compound, 0.05-5 weight part of zinc compound and 0.01-5 weight part of alkali metal compound.

In the present invention, the benzimidazole derivative can be one or more compounds selected from a group consisting of 2-methylbenzimidazole, 2-propylbenzimidazole, 2-butylbenzimidazole, 2-pentylbenzimidazole, 2-hexylbenzimidazole, 2-heptylbenzimidazole, 2-octylbenzimidazole, 2-nonylbenzimidazole, 2-benzyl-6-chlorobenzimidazole, 2-phenylbenzimidazole, 2-chlorobenzimidazole and 2-(2-ethylphenyl)-benzimidazole and/or their salts. The preferable content of the benzimidazole derivative is 0.15 weight part for 100 weight part of water, and 0.33 weight part is more preferable. When the benzimidazole derivative is included at less than 0.1 weight part, the thickness of the film becomes too thin so that heat-resistance is reduced and, on the contrary, when the benzimidazole derivative is included at more than 5 weight part, the stability of the film is reduced.

In the present invention, the benzimidazole derivative is only slightly soluble in water. Thus, to dissolve the benzimidazole derivative in water, an organic acid or an inorganic acid has to be used. The use of acid lowers the pH to about 2.5, so that it is difficult to form a copper, iron or zinc complex on the surface of copper or copper alloy, suggesting that film formation by chemical conversion is delayed and thus coating is not satisfactorily done. Therefore, it is preferred to adjust the pH of the composition to 2.7-3.3 by using ammonia or amine buffer. When the pH is up to 2.7, coating is not satisfactorily done, as explained hereinbefore and, on the other hand, when the pH is at least 3.3, benzimidazole derivative is precipitated. So, the above pH range has to be maintained.

In the present invention, an acid can be one of or a mixture of those selected from a group consisting of organic acids such as formic acid, acetic acid, propionic acid, butyric acid, heptanoic acid, caprylic acid, benzoic acid, glycolic acid, lactic acid, acrylic acid and tartaric acid, or inorganic acids such as sulfuric acid, nitric acid and phosphoric acid. The content of the acid is preferably 0.5-20 weight part for 100 weight part of water and a content of 1-7 weight part is more preferred. If the content of the acid is too low, the solubility of benzimidazole is reduced and, on the other hand, if the content of the acid is too high, alkali is over-used to regulate pH, lowering the stability of a preflux.

An iron compound of the present invention can be one or more selected from a group consisting of iron oxide, ferrous chloride, ferric chloride, iron sulfate, ferric citrate and iron nitrate. The content of the iron compound in water is preferably 0.001-1 weight part and more preferably 0.005-0.3 weight part. If the content of the iron compound is less than 0.001 weight part, heat-resistance is decreased and, on the contrary, if the content is more than 1 weight part, the stability of a film is reduced. Thus, the content has to be in the above range. In particular, to form a film selectively on copper wiring, the content of the iron compound is very important.

In the present invention, the chelating agent can be one or more compounds selected from a group consisting of ethylene diamine tetra acetic acid, diethylene triamine penta acetic acid, triethylene tetramine hexa acetic acid, glycolether diamine tetra acetic acid, nitrilo triacetic acid, imino diacetic acid and 1,2-cyclohexane diamine tetra acetic acid or their salts. The content of the chelating agent is preferably 0.001-1.5 weight part and more preferably 0.01-0.5 weight part. Lower or higher content of the chelating agent reduces the stability of a preflux.

In the present invention, a nickel compound such as nickel nitrate and nickel sulfate is used to enhance heat-resistance and the preferable content of the nickel compound is 0.0001-1 weight part and more preferably 0.001-0.3 weight part for 100 weight part of water. If the content of the nickel compound is too low, heat-resistance is decreased and, on the contrary, if the content of the nickel compound is too high, the stability of a film is decreased and thereby heat-resistance is also decreased.

An iodine compound is used in the present invention to enhance fluidity of the composition, specifically fluidity during coating. The iodine compound is exemplified by hydroiodic acid or its metal salt. It is preferred to add the iodine compound to water by 0.001-1 weight part and more preferred to add the compound by 0.1-0.5 weight part for 100 weight part of water, with which fluidity was recorded as the highest.

In addition, the composition of the invention can additionally include one or more compounds selected from a group consisting of copper compound, zinc compound and alkali metal compound.

The copper compound can be used instead of an iron compound and it can be one or more compounds selected from a group consisting of CuCl, CuCl₂, copper hydroxide, copper phosphate, copper acetate, copper sulfate, copper nitrate and copper bromide. The content of the copper compound is preferably 0.001-1 weight part and more preferably 0.005-0.3 weight part for 100 weight part of water. A content of less than 0.001 weight part reduces heat-resistance and a content of more than 1 weight part decreases the stability of a film, so the content has to be in the above range.

To enhance heat-resistance, a zinc compound can be additionally included in the composition of the invention. At this time, the content of the zinc compound is 0.05-5 weight part and more preferably 0.5-2 weight part. Lower or higher content of the zinc compound reduces the stability of a film and thereby decreases heat-resistance. The zinc compound can be one or more compounds selected from a group consisting of zinc acetate, zinc sulfate, zinc chloride, zinc formate, zinc lactate, zinc citrate and zinc nitrate, but not always limited thereto.

An alkali metal compound can also be included in the composition of the invention to supply an alkali metal. The alkali metal compound is exemplified by potassium chloride or sodium chloride. The content of the alkali metal compound is 0.01-5 weight part and more preferably 0.1-1 weight part for 100 weight part of water. Lower or higher content of the alkali metal compound reduces the stability of a film.

The surface of the copper or copper alloy is treated by grinding, degreasing, soft etching and acid cleaning and then contacted with an aqueous solution containing the composition of the invention at 20-60° C. for 1 second—it takes several minutes by a conventional method such as dipping, spraying and painting by using roller coater or paint brush.

Reference will now be made in detail to a preferred embodiment of the present invention.

### EXAMPLE 1

To 1 l of water was added 5 g of 2-heptylbenzimidazole, 20 g of formic acid, 0.2 g of iron chloride, 0.3 g of ethylene diamine tetra acetic acid, 1 g of nickel nitrate and 5 g of hydroiodic acid, followed by stirring. Ammonia solution was added to adjust the pH to 2.8. A soft etching treated test piece of copper plate was dipped in the stirred solution at 40° C. for one minute, and then taken out to dry with hot air. As a result, the test piece had a 0.3□ thick coating layer on its surface.

In order to measure the soldering wettability, the test piece was left in a heat hardening chamber with 95% relative humidity at 55° C. for 500 hours. As a result, no sign of corrosion on the copper surface was observed.

The test piece was coated with a postflux, followed by dipping in a 280° C. soldering chamber for 15 seconds. After three times of heat-resistance tests, it was confirmed that the surface color was not changed and the surface had excellent soldering stability.

### EXAMPLE 2

An aqueous solution was prepared under the same conditions as Example 1 except that 0.2 g of copper chloride was added instead of iron chloride. A test piece was treated in the same manner as described in Example 1. As a result, the test piece had a 0.3□ thick coating layer on its surface.

In order to measure the soldering wettability, the test piece was left in a heat hardening chamber with 95% relative humidity at 55° C. for 500 hours. As a result, no sign of corrosion on the copper surface was observed.

The test piece was coated with a postflux, followed by dipping in a 280° C. soldering chamber for 15 seconds. After three heat-resistance tests, it was confirmed that the surface color was not changed and the surface had excellent soldering stability.

### EXAMPLE 3

An aqueous solution was prepared under the same conditions as Example 1 except that 15 g of zinc chloride was additionally added. A test piece was treated in the same manner as described in Example 1. As a result, the test piece had a 0.32□ thick coating layer on its surface.

In order to measure the soldering wettability, the test piece was left in a heat hardening chamber with 95% relative humidity at 55° C. for 500 hours. As a result, no sign of corrosion on the copper surface was observed.

The test piece was coated with a postflux, followed by dipping in a 280° C. soldering chamber for 15 seconds. After three times of heat-resistance tests, it was confirmed that the surface color was not changed and the surface had excellent soldering stability.

### COMPARATIVE EXAMPLE 1

To 1 l of water was added 10 g of 2-undecyl-4-methylimidazole and 20□ of acetic acid, and the mixture was fully stirred, resulting in a pH 3.3 solution. A test piece was treated with the solution in the same manner as described in Example 1. As a result, the test piece had a 0.1□ thick coating layer on its surface.

The test piece was left in a heat hardening chamber with 95% relative humidity at 55° C. for 500 hours. As a result, some local pitting was observed on the test piece.

The test piece was coated with a postflux (Soldox FR207, Toppy Fastener), which was then dipped in a 280° C. soldering chamber for 15 seconds. A heat resistance test was performed three times. As a result, it was confirmed that the surface of the test piece was turned into dark brown.

### COMPARATIVE EXAMPLE 2

To 1 l of water was added 5 g of 2-heptylbenzimidazole, 20 g of formic acid, 0.2 g of iron chloride and 0.3 g of ethylene diamine tetra acetic acid, followed by stirring. Ammonia solution was added to adjust the pH to 2.8. A soft etching treated test piece of copper plate was dipped in the stirred solution at 40° C. for one minute, and then taken out to dry with hot air. The thickness of a coating film on the surface of the test piece was 0.5□.

The test piece was left in a heat hardening chamber with 95% relative humidity at 55° C. for 500 hours. As a result, a local pitting was observed on the test piece.

The test piece was coated with a postflux, which was then dipped in a 280° C. soldering chamber for 15 seconds. A heat resistance test was performed three times. As a result, it was confirmed that the surface of the test piece was turned into dark brown.

### INDUSTRIAL APPLICABILITY

As described above, the composition of the present invention has higher heat-resistance than that of the conventional preflux composition, so it can be used when alloying is used instead of soldering.

The composition of the present invention is also characterized by the specificity to a copper plating circuit, which means the composition is able to coat a copper plating circuit selectively when a copper plated circuit and a gold plated circuit coexist.

The present invention can further provide a composition with more enhanced heat-resistance by adding a nickel compound.

While the present invention has been described and illustrated herein with reference to the preferred embodiment thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A preflux composition having enhanced heat-resistance, as a surface treatment agent for copper and copper alloy, which contains 0.1-5 weight part of benz-imidazole derivative of the below formula 1, 0.5-20 weight part of organic acid or inorganic acid, 0.001-1 weight part of iron compound, 0.001-1.5 weight part of chelating agent, 0.0001-1 weight part of nickel compound and 0.01-1 weight part of iodine compound for 100 weight part of water. 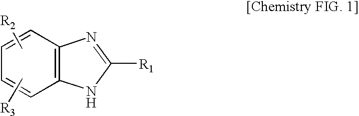
(Wherein, R₁ is an alkyl, halogen, aralkyl or allyl with one or more carbons, and R₂ and R₃ are independently H, C₁˜C₅ alkyl or a halogen.)

2. The preflux composition having enhanced heat-resistance according to claim 1, wherein the iron compound is one or more compounds selected from a group consisting of iron oxide, ferrous chloride, ferric chloride, iron sulfate, ferric citrate and iron nitrate.

3. The preflux composition having enhanced heat-resistance according to claim 1, wherein the chelating agent is one or more compounds selected from a group consisting of ethylene diamine tetra acetic acid, diethylene triamine penta acetic acid, Methylene tetramine hexa acetic acid, glycolether diamine tetra acetic acid, nitrilo triacetic acid, imino diacetic acid, 1,2-cyclohexane diamine tetra acetic acid and their salts.

4. The preflux composition having enhanced heat-resistance according to claim 1, wherein the benzimidazole derivative is one or more compounds selected from a group consisting of 2-methylbenzimidazole, 2-propylbenzimidazole, 2-butylbenzimidazole, 2-pentylbenzimidazole, 2-hexylbenzimidazole, 2-heptylbenzimidazole, 2-octylbenzimidazole, 2-nonylbenzimidazole, 2-benzyl-6-chlorobenzimidazole, 2-phenylbenzimidazole, 2-chlorobenzimidazole, 2-(2-ethylphenyl)-benzimidazole and their salts.

5. The preflux composition having enhanced heat-resistance according to claim 1, wherein the organic acid or inorganic acid is one or more organic acids selected from a group consisting of formic acid, acetic acid, propionic acid, butyric acid, heptanoic acid, caprylic acid, benzoic acid, glycolic acid, lactic acid, acrylic acid and tartaric acid or one or more inorganic acids selected from a group consisting of hydrochloric acid, sulfuric acid, nitric acid and phosphoric acid or a mixture of them.

6. The preflux composition having enhanced heat-resistance according to claim 1, wherein the iodine compound is either hydroiodic acid or its metal salt.

7. The preflux composition having enhanced heat-resistance according to claim 1, wherein the nickel compound is nickel nitrate or nickel sulfate.

8. The preflux composition having enhanced heat-resistance according to claim 1, whose pH is 2.7-3.3.

9. The preflux composition having enhanced heat-resistance according to claim 8, which additionally includes one or more compounds selected from a group consisting of 0.001-1 weight part of copper compound, 0.05-5 weight part of zinc compound and 0.01-5 weight part of alkali metal compound.

10. The preflux composition having enhanced heat-resistance according to claim 9, wherein the copper compound is one or more compounds selected from a group consisting of CuCl, CuCl₂, copper hydroxide, copper phosphate, copper acetate, copper sulfate, copper nitrate and copper bromide.

11. The preflux composition having enhanced heat-resistance according to claim 9, wherein the zinc compound is one or more compounds selected from a group consisting of zinc acetate, zinc sulfate, zinc chloride, zinc formate, zinc lactate, zinc citrate and zinc nitrate.

12. The preflux composition having enhanced heat-resistance according to claim 9, wherein the alkali metal compound is potassium chloride or sodium chloride.

13. The preflux composition having enhanced heat-resistance according to claim 2, whose pH is 2.7-3.3.

14. The preflux composition having enhanced heat-resistance according to claim 3, whose pH is 2.7-3.3.

15. The preflux composition having enhanced heat-resistance according to claim 4, whose pH is 2.7-3.3.

16. The preflux composition having enhanced heat-resistance according to claim 5, whose pH is 2.7-3.3.

17. The preflux composition having enhanced heat-resistance according to claim 6, whose pH is 2.7-3.3.

18. The preflux composition having enhanced heat-resistance according to claim 7, whose pH is 2.7-3.3.
